(19) United States
(12) Patent Application Publication
(10) Pub. No.: US 2004/0073843 A1
(43) Pub. Date: Apr. 15, 2004

(54) Diagnostics using information specific to a subsystem

(76) Inventors: Jason Arthur Dean, Erie, PA (US); Nicholas Edward Roddy, Clifton Park, NY (US); Steven Loncher, Erie, PA (US)

Correspondence Address: Terry M. Sanks, Esquire, Beusse, Brownlee, Bowdoin & Wolter, P.A., Suite 2500, 390 North Orange Avenue, Orlando, FL, 32801, US

(21) Appl. No.: 10/271,499

(22) Filed: Oct. 15, 2002

(51) Int. Cl. G06F 11/30

(52) U.S. Cl. 714/37

(57) ABSTRACT

A method for analyzing fault data specific to a machine comprising a plurality of subsystems, said method comprising collecting fault data from a machine experiencing a malfunction, filtering said fault data with a noise-reduction filter to produce noise-reduced fault data, establishing fault rules specific to a subsystem of said machine, applying fault rules specific to said subsystem to noise-reduced fault data, and predicting at least one repair specific to said subsystem based on said fault rules and said noise-reduced fault data.

### BACKGROUND OF THE INVENTION

This invention relates to diagnostics and more particularly to a system and method for diagnosing a machine, system or process where a software version, customer identification, and/or configuration version is used for determining one or more repairs needed for a malfunction.

A machine, such as a locomotive, or other complex systems, such as industrial processes, medical imaging, telecommunication systems, aerospace systems, power generation systems, etc., include complex subsystems built from components which over time will fail. When a component does fail, it may be difficult to identify the failed component because the effects or problems that the failure has on the subsystem are often neither readily apparent in terms of their source nor unique. Typically, a field engineer will look at a fault log and determine whether a repair is necessary. The ability to automatically diagnose problems that have occurred or will occur in locomotive systems has a positive impact on minimizing locomotive downtime.

Previously, attempts to diagnose problems occurring in a locomotive have been performed by experienced personnel who have in-depth individual training and experience in working with locomotives. Typically, these experienced individuals use available information that has been recorded in a log. Looking through the log, the experienced individual use their accumulated expertise and training in mapping incidents occurring in locomotive systems to problems that may be causing the incidents. If the incident-problem scenario is simple, then this approach works fairly well. However, if the incident-problem scenario is complex, then the engineer may have difficulty in diagnosing and correcting any failures associated with the incidents.

One improvement that was realized in diagnostic systems and tools is the use of computer-based systems to automatically diagnose problems in a locomotive in order to overcome some of the disadvantages associated with relying completely on experienced personnel. Typically, a computer-based system utilizes a mapping between the observed symptoms of the failures and the equipment problems using techniques such as table look-ups, symptom-problem matrices, and production rules.

Approaches like neural networks, decision trees, etc., have been employed to learn based on input data to provide prediction, classification, and function approximation capabilities in the context of diagnostics. Often, such approaches have required structured and relatively static and complete input data sets for learning, and have produced models that resist real-world interpretation. These techniques work well for simplified systems having simple mappings between symptoms and problems. However, complex equipment and process diagnostics seldom have such simple correspondences. Additionally, not all symptoms are necessarily present if a problem has occurred, thus making other approaches more cumbersome.

U.S. Pat. No. 6,343,236, assigned to the assignee of the present invention, discloses a system and method for analyzing fault log data where the system comprises a process for receiving new fault log data comprising a plurality of faults and selecting a plurality of distinct faults from the new fault log data. The process generates at least one distinct fault cluster from the selected plurality of distinct faults. The processor then predicts at least one repair for at least one distinct fault cluster using a plurality of predetermined weighted repair and distinct fault cluster combinations.

U.S. Pat. No. 6,336,065, assigned to the assignee of the present invention, discloses a method for analyzing fault log data and snapshot operational parameter data where a receiving step allows for receiving fault log data comprising a plurality of faults. Respective executing steps allow for executing a set of noise-reduction filters upon the received fault log data to generate notes-reduced fault log data, and for executing a set of candidate snapshot anomalies upon the noise-reduced data to generate data predictive of malfunctions.

Case Based Reasoning (CBR) is another approach that is based on the observation that experiential knowledge (memory of past experiences or cases) is applicable to problem solving as learning rules or behaviors. CBR relies on relatively little pre-processing of raw knowledge, focusing instead on indexing, retrieval, reuse, and archival of cases. In the diagnostic context, a case refers to a problem/solution description pair that represents a diagnosis of a problem and an appropriate repair. CBR assumes cases described by a fixed, known number of descriptive attributes. Conventional CBR systems assume a corpus of fully valid or “gold standard” cases that new incoming cases can be matched against.

Even though fault log data collected by current diagnostic systems contain information specific to a locomotive, such as locomotive identification number or unit and customer identification number, this data is used to track the fault data and not used to diagnose a malfunction. Thus, if a system, such as a fuel injection system, is replaced with a third party supplier's system, in a locomotive, the new fuel injection system may not operate in the same manner as the original system. If the diagnostic system is not provided with rules specific to this new fuel injection system, the malfunction may not be diagnosable with current diagnostic systems.

### BRIEF SUMMARY OF THE INVENTION

This invention is directed to a method and system for providing automated analysis of fault data collected from a malfunctioning machine such as a locomotive, or a system or process, where the machine, system and/or process comprises a plurality of subsystems where a subsystem's software versions, customer identification, and/or configuration versions are considered in predicting one or more possible repair actions. One preferred method comprises collecting fault data from a machine, system and/or process that is experiencing a malfunction. The fault data is then filtered through a noise-reduction filter, thus producing noise-reduced fault data. Fault rules specific to a subsystem of the machine, system, and/or process are established. The fault rules are applied to the noise-reduced fault data. At least one repair prediction is generated from applying the fault rules to the noise-reduced fault data.

In another preferred embodiment, the method comprises collecting fault data from a mobile asset, wherein the mobile asset has a plurality of subsystems, experiencing a malfunction. The fault data is filtered through a noise-reduction filter to produce noise-reduced fault data. In one preferred embodiment, the filter is operable to remove data not specific to a version and/or configuration of a subsystem of the mobile asset which is providing the fault data. A case-based reasoning algorithm specific to a subsystem of the mobile asset is established. The case-based reasoning algorithm specific to the subsystem is applied to the noise-reduced fault data. A prediction of at least one repair specific to the subsystem is made.

The system comprises a fault data collection device that sends collected fault data to a processor where the fault data is filtered. A discriminator generation device, to discriminate based on a software version, customer identification, and/or configuration version of the subsystem, is also connected to the processor. The processor compares the fault data with a fault rule and/or a case-based reasoning algorithm, created by the discriminator generation device, and predicts a repair that is specific to the subsystem.

### BRIEF DESCRIPTION OF THE DRAWINGS

The invention itself, both as to organization and method of operation, may best be understood by reference to the following description in conjunction with the accompanying drawings in which like numbers represent like parts throughout the drawings and in which:

FIG. 1 is an illustration of an exemplary locomotive;

FIG. 2 is a block diagram of exemplary elements comprising the present invention;

FIG. 3 is an exemplary flow chart of the present invention;

FIG. 4 is an exemplary flow chart of the present invention;

FIG. 5 is an exemplary chart of data processed by the present invention; and

FIG. 6 is an exemplary diagram illustrating features of an anomaly detector of the present invention.

### DETAILED DESCRIPTION OF THE INVENTION

With reference to the figures, exemplary embodiments of the invention will now be described. The scope of the invention disclosed is applicable to a plurality of systems, machines, and/or processes. Thus, even though embodiments are described specific to locomotives, or mobile assets, this invention is also applicable to other systems, machines, and/or processes in which operations are monitored and diagnostic systems are utilized to diagnose malfunctions or predict impending failures. Likewise, even though the present invention is described to illustrate exemplary elements needed to comprise the present invention, the present invention may be integrated into existing diagnostics. Additionally, even though the present invention is disclosed specific to Rule-Based systems, it is applicable to other diagnostic software and systems, such as Case-Based Reasoning (CBR) systems which are also disclosed herein.

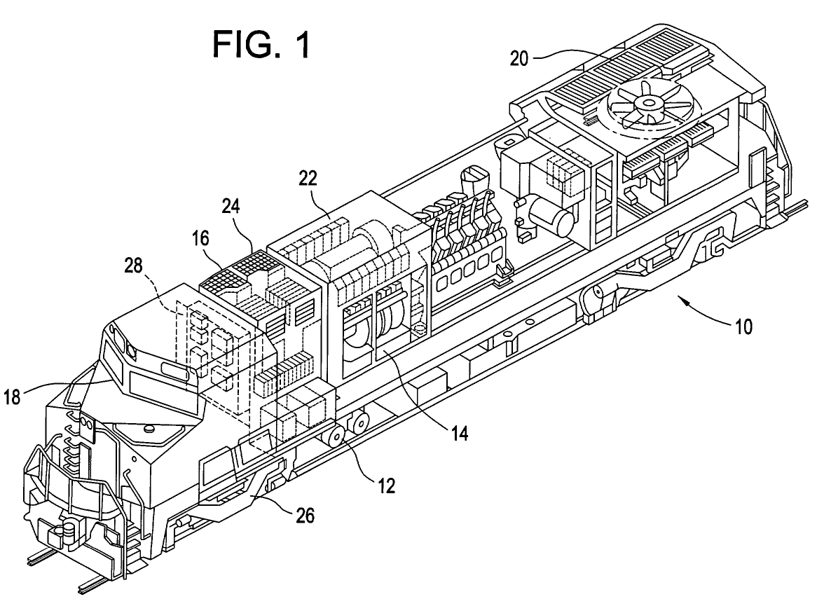

FIG. 1 is an illustration of an exemplary locomotive. The locomotive 10 may be either an AC or DC locomotive. The locomotive 10 is comprised of several complex systems, such as, but not limited to, an air and air brake system 12, an auxiliary alternator system 14, propulsion system 24, an intra-consist communications systems 18, a cable signal system 18, a distributed power control system 26, an engine cooling system 20, an end of train system, an equipment ventilation system 22, and a propulsion system 24. Some of these systems work independent of the other systems, whereas others interact with other systems. The subsystems are monitored by an on-board monitor system 28, which tracks any incidents or faults occurring in any of the systems with an incident or fault log. In one embodiment, an on-board diagnostic system is also on-board to diagnoses the incidents or faults. In another embodiment, the diagnostic system is at a remote monitoring facility. Though the present invention is described for an off-board, or remote, monitoring facility diagnosing a fault, one skilled in the art will recognize that this invention is applicable to on-board diagnostic systems and tools as well.

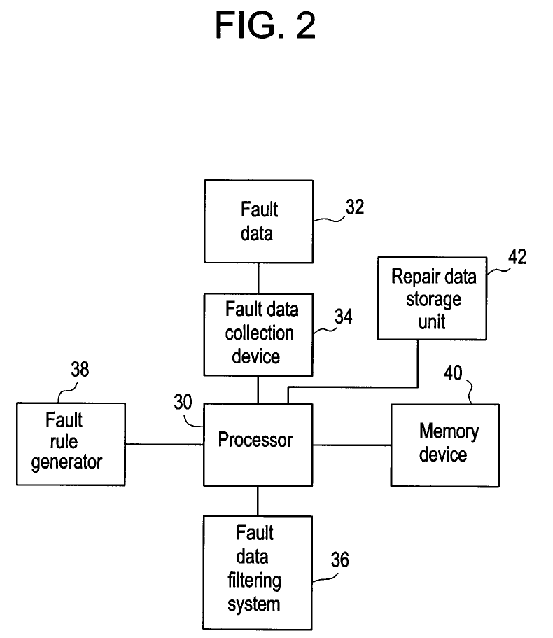

FIG. 2 is an illustration of an exemplary diagnostic system. One skilled in the art will recognize that the present invention may work with, or be integrated into, a plurality of diagnostic systems, or tools, and not just the one illustrated herein. A processor 30 is provided, such as a computer (e.g., UNIX workstation). The processor may comprise, but is not limited to, a hard drive, input devices such as a keyboard, a mouse, magnetic storage media (e.g., tape cartridges or disks), optical storage media (e.g. CD-ROMS), and output devices such as a display and printer. The processor is operable to receive new fault data 32, usually in the form of a fault data log, for analysis. In an exemplary embodiment, a fault data collection device 34 is connected to the processor 30 to provide fault data 32 to the processor 30 for analysis. The data 32 is filtered through a fault data filtering system 36, such as a noise-reduction filter, connected to the processor 30 to remove extraneous data, as discussed below, prior to analysis. A discriminator generation device, such as a fault rule generator 38 is also provided which is also connected to the processor 30. The fault rule generator 38 is used to create a fault rule specific to a subsystem of a malfunctioning machine, system, and/or process where the subsystem's software version, customer identification number, and/or configuration version identifier is used in accessing a fault rule specific to the subsystem. The processor 30, also referred to as an anomaly detector, gathers the fault data 32 and the rules and then predicts a repair based on the information provided. A memory device 40 is connected to the processor 30 and has weight data factors stored therein which are used in predicting the repair. A repair data storage unit 42 is also connected to the processor 30 for retrieving the repair from a list of repairs. The repair data storage unit 42 is also a memory device. In another embodiment, not shown, instead of a fault rule generator 38, a case-based reasoning (CBR) system, generator and/or database is the discriminator generation device that maintains a plurality of solutions, based on a plurality of reasons, such as but not limited to previously encountered problems. The CBR system develops an algorithm that is specific to the fault. In a preferred embodiment, a specific solution is provided to the processor 30 as directed by the processor 30.

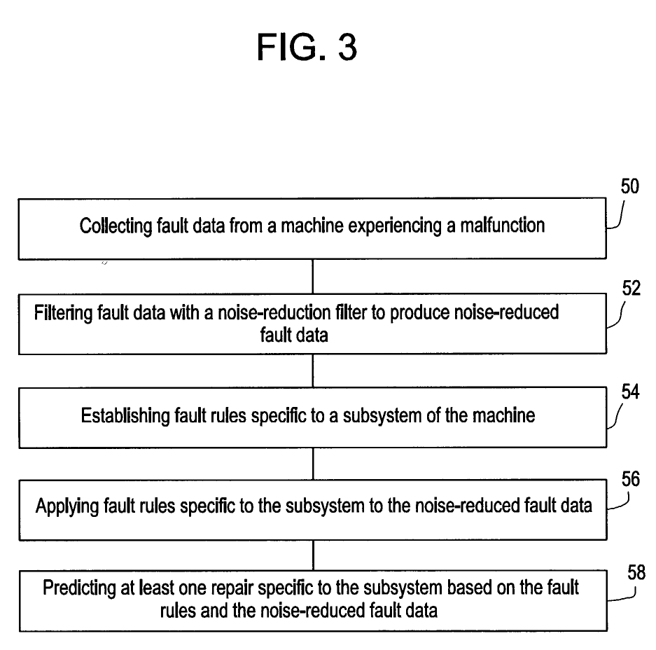

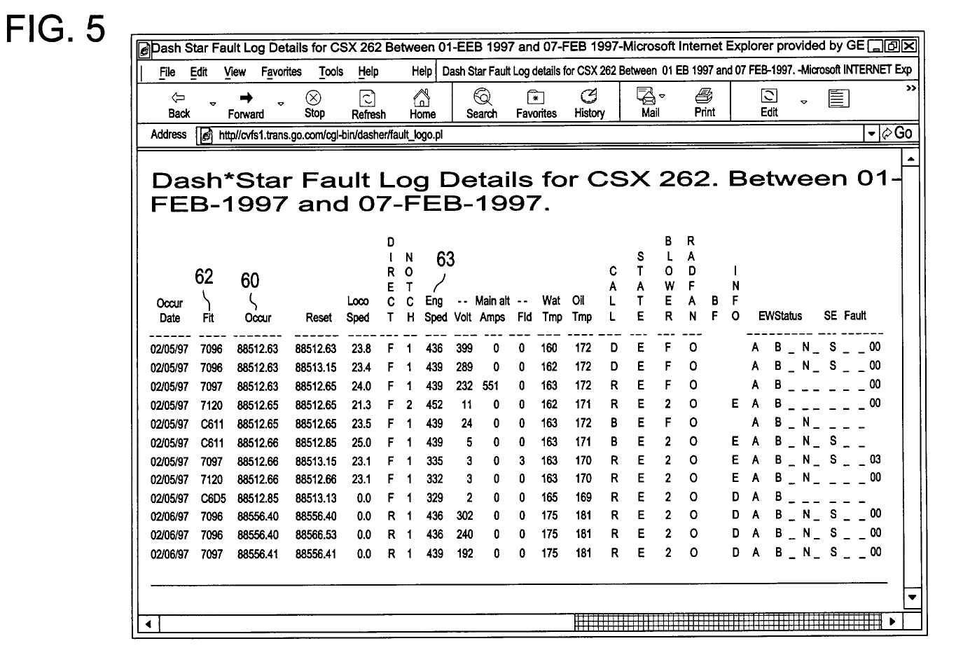

FIG. 3 is an illustration of an exemplary process flow of the present invention. Faults are collected and recorded at the locomotive Step 50 and, in a preferred embodiment, are saved in fault logs. Examples of the types of information contained in the data sent to the fault filtering system 36 can include, but is not limited to, faults occurred 60, fault codes 62, fault code description, engine speed 63, etc., as illustrated in FIG. 5. In a preferred embodiment, information specific to identity the locomotive 10, or the subsystems, which make up the locomotive 10 are also provided in the data sent for diagnosing.

In a preferred embodiment, the fault logs are then sent off-board to a remote monitoring facility. The fault data 32 may be sent directly to the off-board facility or saved in a storage device prior to sending it off-board. The fault logs 32 are filtered in a noise reduction filter system Step 52. The sort of data that may be filtered out include, but is not limited to, non-recurring events that are explainable given a condition the locomotive encountered at the time the fault was logged. For example, if an exhaust manifold runs hot when a locomotive is passing through a tunnel but then returns to normal operation conditions after the locomotive 10 exits the tunnel, a fault may be reported which the noise reduction filter would filter. In another preferred embodiment the noise-reduction filters are dependent on configurations and versions of the subsystems or components which data is being collected from. Thus the noise-reduction may be specific to a customer identification, configuration version and/or software version of the component and/or subsystem.

The filtered fault data is then passed through an anomaly detector 30, typically a processor as discussed above. The anomaly detector 30 analyzes the fault using expert, or fault rules Step 56, which also consider configuration information specific to the subsystem experiencing the anomaly or malfunction. In one preferred embodiment, the fault rules are previously established Step 54. In another preferred embodiment, the anomaly detector 30 is operable to update the fault rules as required, Step 54. As an example, if a fuel injector fault is detected, the anomaly detector 30 will first ascertain a make or model of the fuel injector. Based on the make or model, the anomaly detector 30 will apply diagnostic rules specific to the make or model of the fuel injector. Likewise, if the subsystem comprises software, the software version, such as if a newer software version is available, of the subsystem at issue would be used by the anomaly detector 30 to select diagnostic specific rules that are specific to the software version.

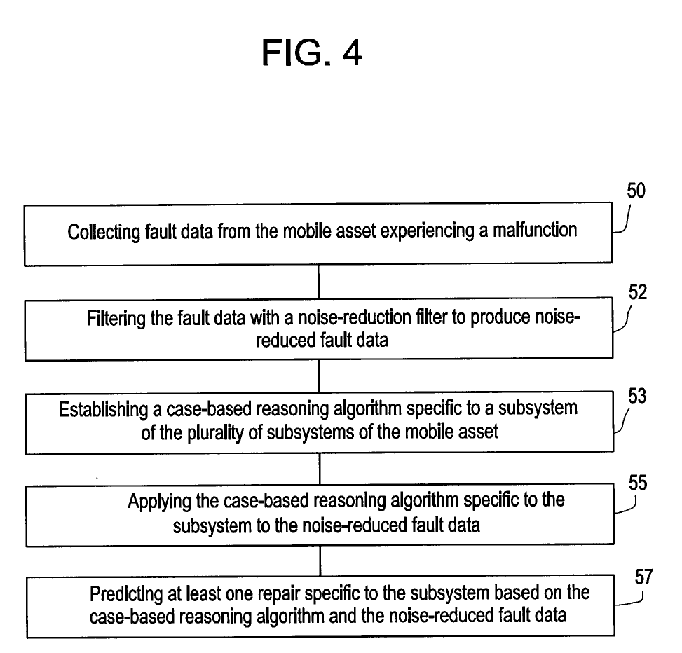

Similarly, with respect to a CBR system as illustrated in FIG. 4, a case-based reasoning algorithm specific to a subsystem is established, Step 53. The case-based reasoning algorithm is then applied to the noise-reduced fault data, Step 55. One repair specific to the subsystem based on the case-based reasoning algorithm and the noise-reduced fault data is then predicted, Step 57.

In another preferred embodiment, the specific locomotive's designation is provided with the fault data wherein the expert rules specific to that designation include data about all subsystem changes installed on the locomotive 10. When the fault data 32 is supplied to the anomaly detector 30, the locomotive designation is submitted to the rules, that take the identification and pull up diagnostic rules specific to the given locomotive 10.

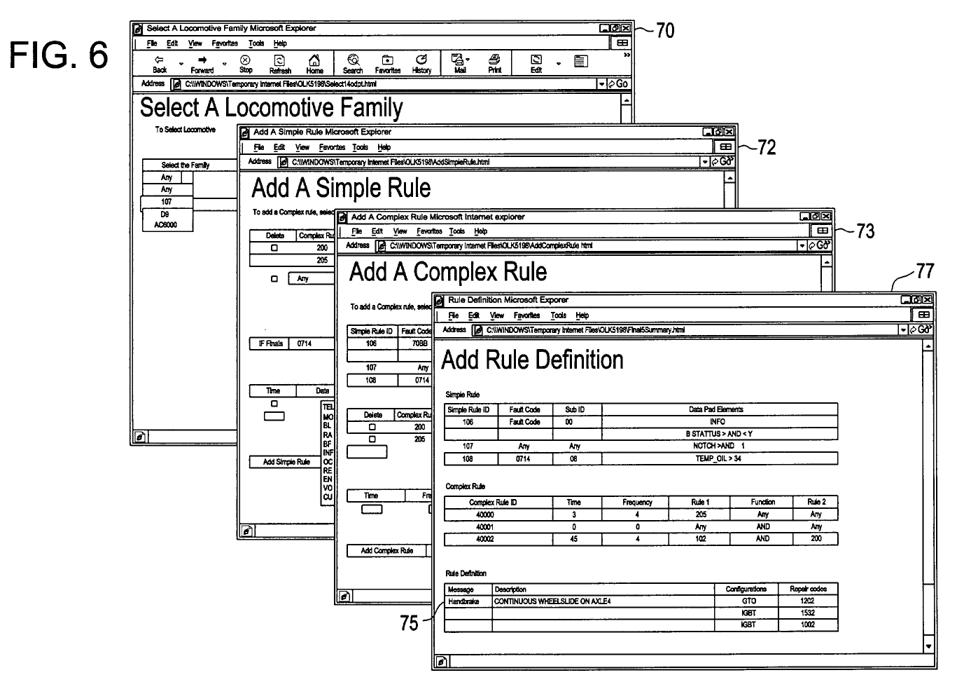

The anomaly detector 30 is a programmable device. The device 30 can be programmed specific to a certain configuration. For example, as illustrated in FIG. 6, the anomaly detector 30 is programmable to select a locomotive family 70. From there, a simple rule 72 and/or a complex rule 73 can be entered where either rule can be specific to a certain component, such as a handbrake 75, or any other subsystem. In another preferred embodiment, a rule definition is specific to a certain locomotive 10 where specific information about all of the locomotive's subsystems is built into that rule 77. Thus if there is a locomotive A and a locomotive B, which are the same model, but where various subsystems have been replaced with a secondary supplier's parts, the rules are provided specific to each locomotive including rules specific to the secondary supplier's parts. Once the anomaly detector 30 is engaged, the system predicts at least one repair that the locomotive 10 needs Step 58, based on the fault data and the rule specific to the given subsystem that was causing the fault. The prediction can be based on a plurality of repair prediction methods. For example, a weighted repair data factor, contained in the memory device 40, is used in determining a repair.

While the invention has been described in what is presently considered to be a preferred embodiment, many variations and modifications will become apparent to those skilled in the art. Accordingly, it is intended that the invention not be limited to the specific illustrative embodiment, but be interpreted within the full spirit and scope of the appended claims.

What is claimed is:

1. A method for analyzing fault data from at least one of a machine, system, and process to determine a repair, said method comprising:
(a) analyzing said fault data with at least one of a fault rule and a case-based reasoning algorithm;
(b) factoring in said at least one of a software version, a customer identification, and a configuration version of at least one of said machine, system, and process; and
(c) determining a predicted repair based on at least one of said fault rule and said case-based reasoning algorithm in combination with at least one of said software version, said customer identification and said configuration version.

2. The method of claim 1 further comprising creating said fault rule that is specific to at least one of said software version, a customer identification, and a configuration version.

3. The method of claim 1 further comprising filtering said fault data prior to analyzing said fault data.

4. The method of claim 3 wherein filtering said fault data comprises providing a noise reduction filter to filter said fault data.

5. The method of claim 1 wherein a weighted factor is used to determine a predicted repair.

6. The method of claim 1 wherein a predicted repair is extracted from a repair data storage unit.

7. The method of claim 1 further comprising creating said case-based algorithm that is specific to at least one of said software version, a customer identification, and a configuration version.

8. The method of claim 4 wherein providing a noise reduction filter further comprises providing a noise-reduction filter that filters data dependent on at least one of a software version, a customer identification, and a configuration version of at least one of said machine, system, and process.

9. The method of claim 1 wherein said fault rule and said case-based reasoning algorithm are used simultaneously.

10. A method for analyzing fault data specific to a machine comprising a plurality of subsystems, said method comprising:
(a) collecting fault data from a machine experiencing a malfunction;
(b) filtering said fault data with a noise-reduction filter to produce noise-reduced fault data;
(c) establishing a fault rule specific to a subsystem of said plurality of subsystems of said machine;
(d) applying said fault rule specific to said subsystem to said noise-reduced fault data; and
(e) predicting at least one repair specific to said subsystem based on said fault rules and said noise-reduced fault data.

11. The method of claim 10 wherein establishing fault rules further comprises establishing fault rules comprising data specific to at least one of a software version, a customer identification, and a configuration version of said subsystem.

12. The method of claim 10 wherein collecting fault data further comprises cataloging fault data based on a number of times a fault occurs over a determined time period.

13. The method of claim 10 wherein predicting at least one repair further comprises selecting at least one repair using a predetermined weighted repair factor and adding an assigned weighted repair factor to a related repair.

14. The method of claim 10 further comprising storing fault data for later filtering said fault data.

15. The method of claim 10 wherein applying fault rules further comprising applying fault rules specific to a fault identification received from said machine.

16. The method of claim 10 further comprising providing a repair data storage unit.

17. The method of claim 16 further comprising extracting a repair from said repair data storage unit.

18. The method of claim 10 wherein said filtering of said fault data with a noise-reduction filter further comprises filtering said fault data with said noise-reduction filter wherein said noise-reduction filter is dependent on at least one of a software version, a customer identification, and a configuration version of said machine.

19. A method for analyzing fault data specific to a mobile asset comprising a plurality of subsystems, said method comprising:
(a) collecting fault data from said mobile asset experiencing a malfunction;
(b) filtering said fault data with a noise-reduction filter to produce noise-reduced fault data;
(c) establishing a case-based reasoning algorithm specific to a subsystem of said plurality of subsystems of said mobile asset;
(d) applying said case-based reasoning algorithm specific to said subsystem to noise-reduced fault data; and
(e) predicting at least one repair specific to said subsystem based on said case-based reasoning algorithm and said noise-reduced fault data.

20. The method of claim 19 wherein predicting at least one repair further comprises selecting at least one repair using a predetermined weighted repair factor and adding an assigned weighted repair factor to a related repair.

21. The method of claim 19 wherein applying said case-based reasoning algorithm further comprising applying said algorithm specific to a fault identification received from said machine.

22. The method of claim 19 further comprising providing a repair data storage unit.

23. The method of claim 21 further comprising extracting a repair from said repair data storage unit.

24. The method of claim 19 wherein the filtering said fault data with a noise-reduction filter further comprises filtering said fault data with said noise-reduction filter wherein said noise-reduction filter is dependent on at least one of a software version, a customer identification, and a configuration version of at least one of said mobile asset and said subsystem.

25. A system for analyzing fault data specific to a subsystem of a machine, said system comprising:
(a) a fault data collection device for collecting and storing fault data from a malfunctioning machine;
(b) a processor connected to said fault data collection device;
(c) a fault data filtering system connected to said processor;
(d) a discriminator generation device to discriminate based on at least one of a software version, a customer identification, and a configuration version of said subsystem; and
(e) wherein said processor compares said fault data with at least a fault rule and an algorithm generated by said discriminator generation device and predicts a repair specific to said subsystem.

26. The system of claim 25 wherein said fault data collection device comprises a memory device configured to store fault data.

27. The system of claim 25 wherein said processor is operable to select a plurality of faults from new fault data.

28. The system of claim 25 further comprising a memory device connected to said processor comprising a weight data factor used to predict a repair.

29. The system of claim 25 wherein said discrimination generation device is a fault rule generator operable to create said fault rule specific to at least one of a software version, a customer identification, and a configuration version of said subsystem.

30. The system of claim 29 wherein said fault rule generator is programmable to create new fault rules.

31. The system of claim 25 wherein said discrimination generation device is a case-based reasoning system operable to create said algorithm specific to at least one of a software version, a customer identification, and a configuration version of said subsystem.

32. The system of claim 25 further comprising a repair data storage unit.

33. The system of claim 32 wherein a predicted repair is retrieved from said repair data storage unit.
